(19) United States
(12) Patent Application Publication
(10) Pub. No.: US 2024/0184596 A1
(43) Pub. Date: Jun. 6, 2024

(54) COMPRESSING FIRMWARE DATA

(71) Applicant: Micron Technology, Inc., Boise, ID (US)

(72) Inventors: Jiawei Wang, Shanghai (CN); Zephyr Yu, Shanghai (CN); Yaming Lu, Shanghai (CN); Long Lu, Shanghai (CN); Huachen Li, Shanghai (CN); Wenjun Wu, Shanghai (CN); Chen Huang, Shanghai (CN)

(21) Appl. No.: 17/904,081

(22) PCT Filed: Mar. 17, 2022
(86) PCT No.: PCT/CN2022/081375

§ 371 Date: Aug. 11, 2022

(51) Int. Cl. G06F 9/30

(52) U.S. Cl. CPC G06F 9/30178

(57) ABSTRACT

Methods, systems, and devices for compressing firmware data are described. A memory system may access firmware data associated with the memory system that includes bank data. The memory system may determine whether the bank data in the firmware data is compressed and, in cases that the bank data is compressed, the memory system may decompress the bank data prior to storing the bank data at a controller of the memory system. In some examples, a bank header in the firmware data may include information for the memory system to decompress the bank data. For example, the bank header may indicate the size of the compressed bank data associated with each bank. Additionally, the memory system may read the compressed bank data according to the indicated size and store the bank data at the controller or at a memory device of the memory system.

### CROSS REFERENCE

The present Application for Patent is a 371 national phase filing of International Patent Application No. PCT/CN2022/081375 by Wang et al., entitled “COMPRESSING FIRMWARE DATA,” filed Mar. 17, 2022, assigned to the assignee hereof, and expressly incorporated by reference herein.

### FIELD OF TECHNOLOGY

The following relates to one or more systems for memory, including compressing firmware data.

### BACKGROUND

Memory devices are widely used to store information in various electronic devices such as computers, user devices, wireless communication devices, cameras, digital displays, and the like. Information is stored by programming memory cells within a memory device to various states. For example, binary memory cells may be programmed to one of two supported states, often corresponding to a logic 1 or a logic 0. In some examples, a single memory cell may support more than two possible states, any one of which may be stored by the memory cell. To access information stored by a memory device, a component may read (e.g., sense, detect, retrieve, identify, determine, evaluate) the state of one or more memory cells within the memory device. To store information, a component may write (e.g., program, set, assign) one or more memory cells within the memory device to corresponding states.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), 3-dimensional cross-point memory (3D cross point), not-or (NOR) and not-and (NAND) memory devices, and others. Memory devices may be described in terms of volatile configurations or non-volatile configurations. Volatile memory cells (e.g., DRAM) may lose their programmed states over time unless they are periodically refreshed by an external power source. Non-volatile memory cells (e.g., NAND) may maintain their programmed states for extended periods of time even in the absence of an external power source.

### BRIEF DESCRIPTION OF THE DRAWINGS

FIG. 1 illustrates an example of a system that supports compressing firmware data in accordance with examples as disclosed herein.

FIGS. 2A and 2B illustrate example firmware images that support compressing firmware data in accordance with examples as disclosed herein.

FIG. 3 illustrates an example of a process flow that supports compressing firmware data in accordance with examples as disclosed herein.

FIG. 4 shows a block diagram of a memory system that supports compressing firmware data in accordance with examples as disclosed herein.

FIG. 5 shows a flowchart illustrating a method or methods that support compressing firmware data in accordance with examples as disclosed herein.

### DETAILED DESCRIPTION

Some memory systems may execute firmware data (e.g., using a controller of the memory system to run an on-chip system) in order to perform a boot-up procedure or execute a request from a host system (e.g., to maintain data). For example, the memory system may access the firmware data from a memory device of the memory system and initialize a system on-chip by executing the firmware data during the boot-up or initialization procedure. In some cases, the memory system may receive firmware data from a host system and store the received firmware data at the memory device of the memory system (e.g., in response to programming manufacturer code or updating firmware code). The firmware data may include bank data associated with each bank at the memory system and the memory system may execute the bank data associated with each bank (e.g., in response to running the system on-chip). In some cases, the bank data within the firmware data may be aligned according to a preconfigured granularity. That is, the firmware data may include bank data associated with a set of banks at the memory system and may additionally include dummy data to align the data for each bank according to the preconfigured granularity. In an example of the bank data being aligned according to a 16 k alignment, if the bank data is 12 k bytes, the firmware data may include 4 k bytes of dummy data corresponding to the bank to achieve the 16 k alignment. In some instances, however, aligning the bank data according to a preconfigured granularity may increase the size of the bank data and, by extension, of the firmware data.

Accordingly, the techniques as described herein provide for compressed bank data to decrease the size of the bank data and firmware data. Specifically, the bank data may be compressed by refraining from aligning the data for each bank (e.g., and not including the dummy data to achieve the alignment). Here, the firmware data may include an indication (e.g., within a header of the firmware data) that the bank data within the firmware data is compressed (e.g., not aligned to a preconfigured granularity). Additionally, the firmware data may include a bank header indicating a quantity of data sets associated with a bank that are included in the firmware data and the size of each of the quantity of data sets. Based on the information within the bank header, the memory system may identify bank data associated with each bank within the firmware data and store the identified bank data at a memory device of the memory system (e.g., in response to receiving firmware data from host). In some cases, decreasing the size of the firmware data may decrease an amount of memory to store the firmware data (e.g., at a host system) and decrease a size of the firmware data sent by the host system to the memory system.

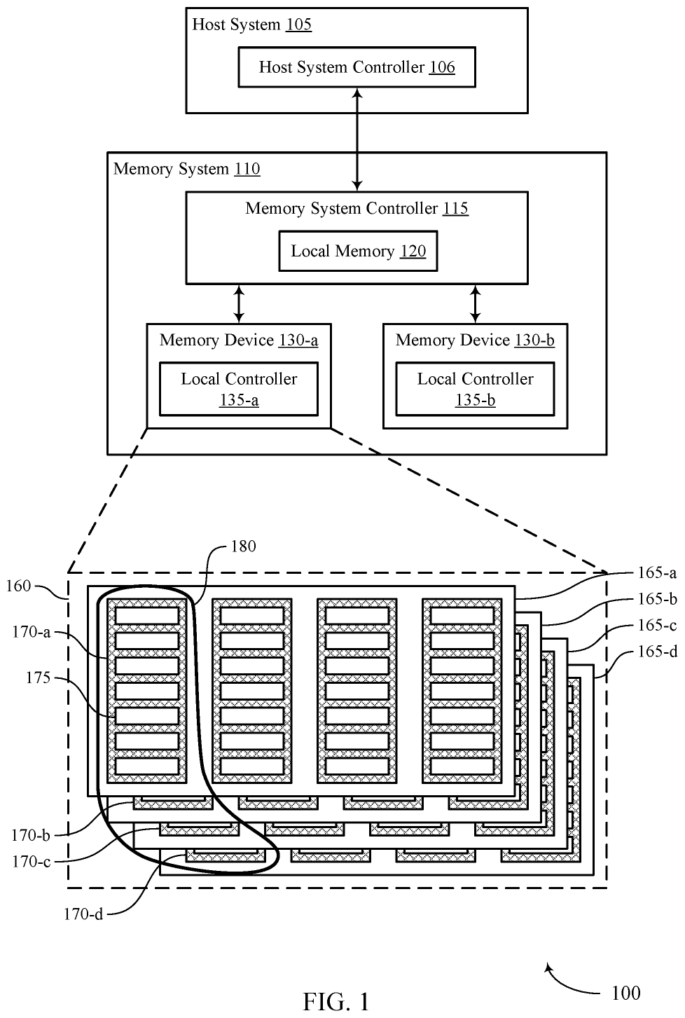

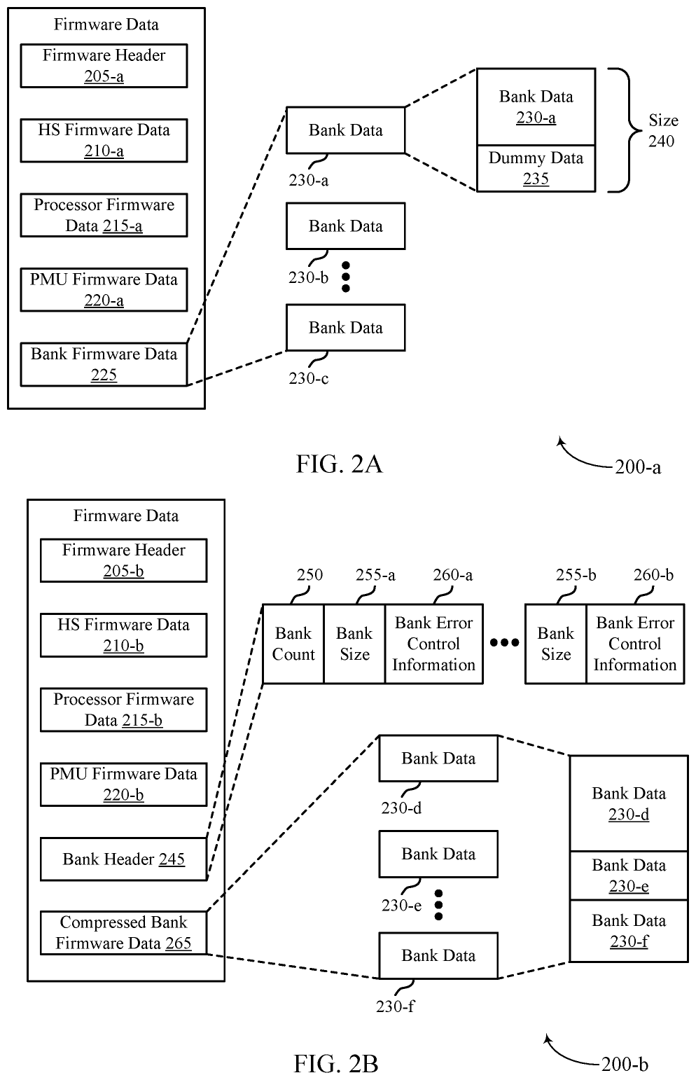

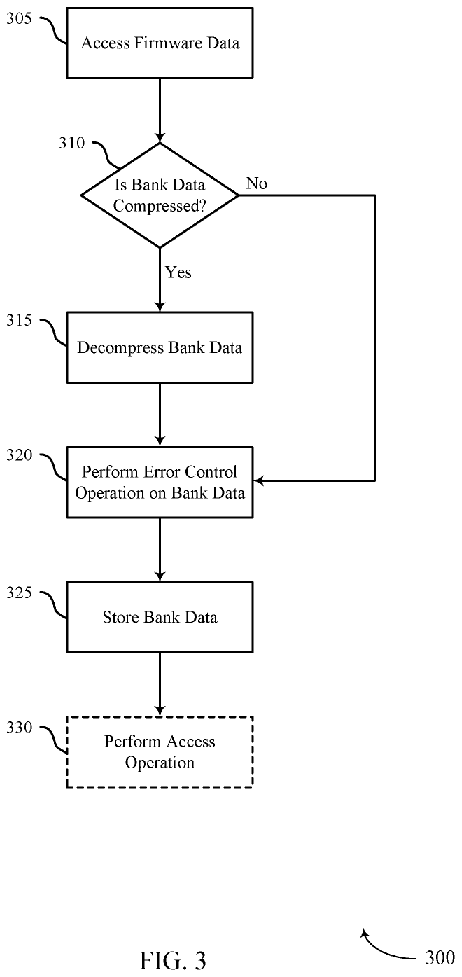

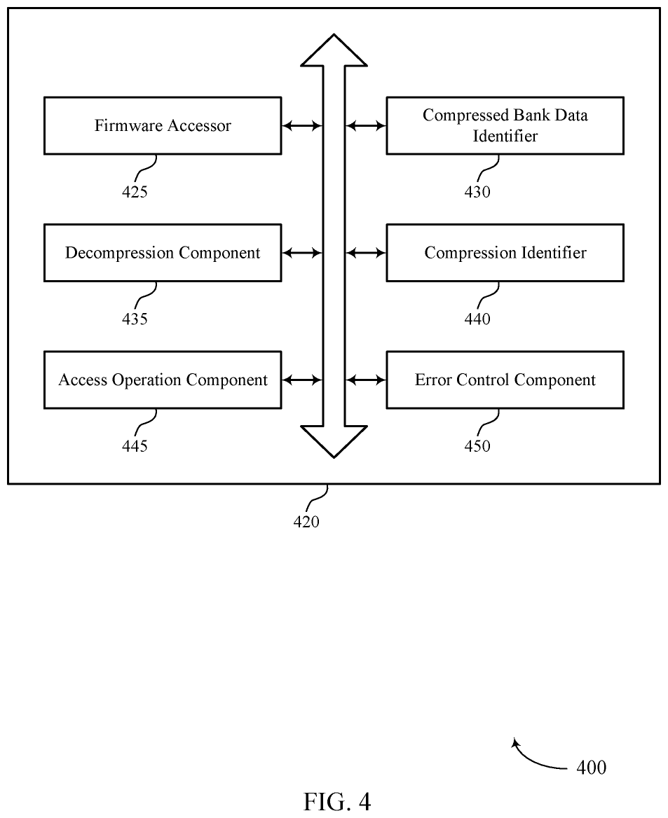

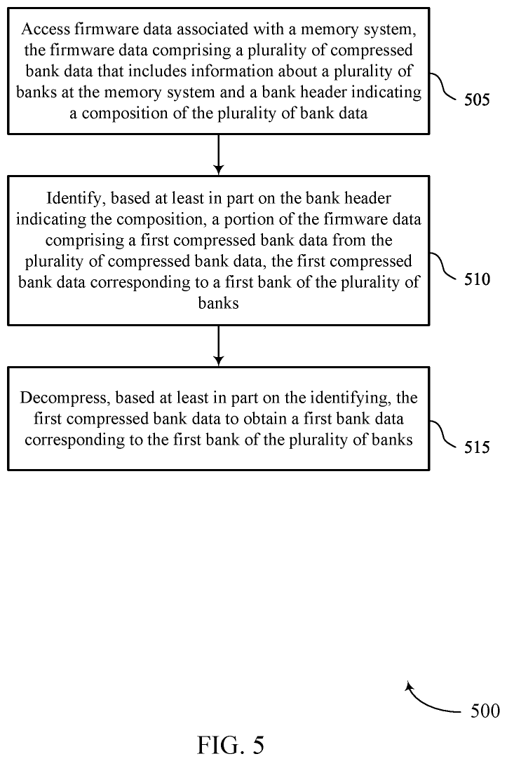

Features of the disclosure are initially described in the context of a system with reference to FIG. 1. Features of the disclosure are described in the context of firmware images and a process flow with reference to FIGS. 2A, 2B, and 3. These and other features of the disclosure are further illustrated by and described in the context of an apparatus diagram and flowchart that relate to compressing firmware data with reference to FIGS. 4 and 5.

FIG. 1 illustrates an example of a system 100 that supports compressing firmware data in accordance with examples as disclosed herein. The system 100 includes a host system 105 coupled with a memory system 110.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMN), a small outline DIMM (SO-DIMM), or a non-volatile DIMM (NVDIMM), among other possibilities.

The system 100 may be included in a computing device such as a desktop computer, a laptop computer, a network server, a mobile device, a vehicle (e.g., airplane, drone, train, automobile, or other conveyance), an Internet of Things (IoT) enabled device, an embedded computer (e.g., one included in a vehicle, industrial equipment, or a networked commercial device), or any other computing device that includes memory and a processing device.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally or alternatively include static random access memory (SRAM) or other memory that may be used by the memory system controller 115 for internal storage or calculations, for example, related to the functions ascribed herein to the memory system controller 115.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (RAM) (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on a same die or within a same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a memory die 160. For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, plans 165 may refer to groups of blocks 170, and in some cases, concurrent operations may take place within different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different planes 165 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in a same page 175 may share (e.g., be coupled with) a common word line, and memory cells in a same string may share (e.g., be coupled with) a common digit line (which may alternatively be referred to as a bit line).

For some NAND architectures, memory cells may be read and programmed (e.g., written) at a first level of granularity (e.g., at the page level of granularity) but may be erased at a second level of granularity (e.g., at the block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

The memory system 110 may access firmware data (or “firmware,” “firmware code,” “firmware image”). The firmware data may be low-level code (e.g., operating code) that enables the memory system 110 to subsequently perform higher-level functions using more complex software. In some cases, the memory system controller 115 may access the firmware data as part of a start-up or boot-up procedure of the memory system 110. Additionally, the memory system controller 115 may access the firmware data as part of a firmware update (e.g., to update the firmware data) or in response to a programming manufacturer code. Additionally, the memory system controller 115 may access the firmware data to run an on-chip system at the memory system 110. During a start-up or boot-up procedure or an update of the firmware data, the memory system 110 may access the firmware data by receiving the firmware data from the host system 105.

The firmware data may include data associated with a processor of the memory system 110, data associated with a power management unit (PMU) of the memory system 110 (e.g., PMU firmware data), data associated with an HS of the memory system 110, and data associated with the banks of the memory system 110 (e.g., bank firmware data). In response to receiving the firmware data from the host system 105, the memory system 110 may store the firmware data at a memory device 130 of the memory system (or, in some cases, at the memory system controller 115). For example, the memory system 110 may store block firmware at a block 170 of the memory system 110. Additionally, the memory system 110 may store bank firmware data at a page 175 within the block 170 (e.g., storing the block firmware data). In some examples, bank firmware data may correspond to one page of the block firmware data.

In some cases, the memory system 110 may execute portions of the stored firmware data to operate one or more components of the memory system 110. For example, the memory system 110 may execute a portion of the firmware data associated with the PMU to operate the PMU. Additionally, the memory system 110 may execute a portion of the firmware data associated with a bank.

In some cases, the bank firmware data may include data stored in each page 175 of a block 170 storing firmware data. In some cases, the bank data within the firmware data received from the host system 105 may be aligned according to a preconfigured granularity. Here, the firmware data may include data for each bank in addition to dummy data that aligns the data for each bank according to the preconfigured granularity. In an example of the bank data being aligned according to a 16 k alignment, if the bank data in the firmware is 12 k bytes, the firmware data may include 4 k bytes of dummy data corresponding to a bank to achieve the 16 k alignment. In cases that the memory system 110 receives bank data that is aligned according to a preconfigured granularity, the memory system 110 may identify the bank data associated with each bank based on the alignment and may store the identified bank data at a memory device 130 of the memory system 110 (or, in some cases, at the memory system controller 115). In some instances, however, aligning the bank data according to a preconfigured granularity may increase the size of the bank data and, by extension, of the firmware data communicated to the memory system 110 by the host system 105.

In some cases, the firmware data may include compressed bank data to decrease the size of the bank data and firmware data. Specifically, the bank data may be compressed by refraining from aligning the data for each bank (e.g., and not including the dummy data to achieve the alignment). Here, the firmware data (e.g., received from a host system 105) may include an indication (e.g., within a header of the firmware data) that the bank data within the firmware data is compressed (e.g., not aligned to a preconfigured granularity). Additionally, the firmware data may include a bank header indicating a quantity of data sets associated with a bank that are included in the firmware data and the size of each of the quantity of data sets. Based on the information within the bank header, the memory system 110 may read (e.g., identify) the bank data associated with each bank and store the identified bank data in a memory device 130 of the memory system (e.g., within a page 175 of a block 170 storing firmware in the memory device 130). Additionally or alternatively, the memory system 110 may store the identified bank data at the memory system controller 115. In some cases, decreasing the size of the firmware data may decrease an amount of memory to store the firmware data (e.g., at a host system 105) and decrease a size of the firmware data sent by the host system 105 to the memory system 110.

The system 100 may include any quantity of non-transitory computer readable media that support compressing firmware data. For example, the host system 105, the memory system controller 115, or a memory device 130 (e.g., a local controller 135) may include or otherwise may access one or more non-transitory computer readable media storing instructions (e.g., firmware) for performing the functions ascribed herein to the host system 105, memory system controller 115, or memory device 130. For example, such instructions, if executed by the host system 105 (e.g., by the host system controller 106), by the memory system controller 115, or by a memory device 130 (e.g., by a local controller 135), may cause the host system 105, memory system controller 115, or memory device 130 to perform one or more associated functions as described herein.

FIGS. 2A and 2B illustrate examples of firmware data 200 that support compressing firmware data in accordance with examples as disclosed herein. In some cases, the firmware data 200 may include aspects of firmware data as described with reference to FIG. 1. For example, a memory system as described with reference to FIG. 1 may access, read, and execute the firmware data as described with FIG. 1 (e.g., as part of a start-up or boot-up procedure).

The firmware data 200 may include a firmware header 205, HS firmware data 210, processor firmware data 215, and PMU firmware data 220. The firmware header 205 may indicate a composition of the firmware data 200. In some examples, a memory system (e.g., a memory system controller) may execute the HS firmware data 210 prior to operating an HS of the memory system, the memory system may execute the processor firmware data 215 prior to operating a processor of the memory system, and the memory system may execute the PMU firmware data 220 prior to operating a PMU of the memory system. The firmware data 200 may additionally include bank data 230.

The firmware data 200 may include bank firmware data 225 that is not compressed or compressed bank firmware data 265. Specifically, FIG. 2A illustrates an example of firmware data 200-a that includes bank firmware data 225 that is not compressed while FIG. 2B illustrates an example of firmware data 200-b that includes compressed bank firmware data 265. In some cases, the firmware header 205 may include an indication of whether the bank data 230 is within bank firmware data 225 that is not compressed or within compressed bank firmware data 265.

FIG. 2A may illustrate firmware data 200-a that includes the firmware header 205-a, the HS firmware data 210-a, the processor firmware data 215-a, PMU firmware data 220-a, and bank firmware data 225. The firmware header 205-a may indicate the composition of the firmware data 200-a. For example, the firmware header 205-a may indicate that the firmware data 200-a includes the HS firmware data 210-a, the processor firmware data 215-a, PMU firmware data 220-a, and bank firmware data 225. Additionally, the firmware header 205-a may indicate a size of the HS firmware data 210-a, the processor firmware data 215-a, PMU firmware data 220-a, and bank firmware data 225. In some cases, the firmware header 205-a may additionally include error control information associated with the data in the firmware data 200-a. For example, the firmware header 205-a may include cyclic redundancy check (CRC) data associated with each of the HS firmware data 210-a, the processor firmware data 215-a, PMU firmware data 220-a, and bank firmware data 225. In some cases, a memory system may perform an error control operation on the data within the firmware data 200-a (e.g., to detect and in some cases correct errors within the firmware data 200-a) based on the error control information. In some cases, the firmware header 205-a may include additional bits to increase a reliability of the data within the firmware header 205-a. For example, the firmware header 205-a may include 32 bytes of data associated with a cryptographic hash algorithm that may improve a reliability of the data within the firmware header 205-a as compared to a firmware header 205 that does not include the cryptographic hash algorithm.

The firmware header 205-a may additionally include an indication of whether the bank firmware data 225 is compressed. For example, a bit of the firmware header 205-a may indicate whether the bank data 230 is compressed. In the example of the firmware data 200-a, the firmware header 205-a may indicate that the bank firmware data 225 is not compressed. That is, the bank firmware data 225 may include bank data 230 that is aligned according to a preconfigured granularity (e.g., according to the size 240). In some cases, the dummy data 235 may include bits that are a preconfigured or predefined value (e.g., each bit in the dummy data 235 may be a logic value ‘0’ or a logic value ‘1’). In some other cases, the dummy data 235 may include bits that are otherwise set to values that do not correspond to executable bank data 230.

To achieve the alignment according to the size 240, the bank firmware data 225 may include bank data 230 and dummy data 235 that aligns the bank data according to the size 240. For example, the bank data 230-a may be aligned according to a size 240 of 16 k bytes. Here, the bank data 230-a may include a quantity of bits that is less than 16 k and the dummy data 235 may include a quantity of bits corresponding to a difference between the size 240 and the quantity of bits in the bank data 230-a. Thus, the dummy data 235 may align the bank data 230 within the bank firmware data 225 according to the size 240.

In an example of a memory system that accesses the firmware data 200-a, the memory system may determine that the bank firmware data 225 is not compressed based on an indication within the firmware header 205-a. Then, the memory system may read the bank data 230 based on the bank data 230 being aligned according to the size 240. Then, the memory system (e.g., a memory system controller, a local controller) may store the bank data 230 and, in some cases, execute the bank data 230.

FIG. 2B may illustrate firmware data 200-b that includes the firmware header 205-b, the HS firmware data 210-b, the processor firmware data 215-b, PMU firmware data 220-b, and compressed bank firmware data 265. The firmware header 205-b may indicate the composition of the firmware data 200-b. For example, the firmware header 205-b may indicate that the firmware data 200-b includes the HS firmware data 210-b, the processor firmware data 215-b, PMU firmware data 220-b, and the compressed bank firmware data 265. Additionally, the firmware header 205-b may indicate a size of the HS firmware data 210-b, the processor firmware data 215-b, PMU firmware data 220-b, and the compressed bank firmware data 265. In some cases, the firmware header 205-b may additionally include error control information associated with the data in the firmware data 200-b. For example, the firmware header 205-b may include CRC data associated with each of the HS firmware data 210-b, the processor firmware data 215-b, PMU firmware data 220-b, and the compressed bank firmware data 265. In some cases, a memory system may perform an error control operation on the data within the firmware data 200-b (e.g., to detect and in some cases correct errors within the firmware data 200-b) based on the error control information. In some cases, the firmware header 205-b may include additional bits to increase a reliability of the data within the firmware header 205-b. For example, the firmware header 205-b may include 32 bytes of data associated with a cryptographic hash algorithm that may improve a reliability of the data within the firmware header 205-b as compared to a firmware header 205 that does not include the cryptographic hash algorithm.

The firmware header 205-b may additionally include an indication of whether the bank data 230 is compressed. For example, a highest bit of the firmware header 205-b may indicate whether the bank data 230 is compressed. In the example of the firmware data 200-b, the firmware header 205-b may indicate that the bank data 230 is compressed (e.g., that the firmware data 200-b includes compressed bank firmware data 265). That is, the bank data 23 may not be aligned according to any preconfigured size (e.g., the compressed bank firmware data 265 does not include dummy data 235 to align the bank data 230). Instead, the compressed bank firmware data 265 includes bank data that is contiguous. For example, each bank data 230 may be merged into one binary compressed bank firmware data 265 (e.g., based on a compression algorithm).

In the example that the firmware data 200-b includes compressed bank firmware data 265, the firmware data 200-b may additionally include a bank header 245 indicating a composition of the compressed bank firmware data 265. The bank header 245 may include a bank count 250 indicating the quantity of banks for which the compressed bank firmware data 265 includes bank data 230. For example, the bank count 250 may indicate the quantity of bank data 230 within the compressed bank firmware data 265. Additionally, the bank header 245 may include a bank size 255 indicating, for each bank data 230 within the compressed bank firmware data 265, a size of the bank data 230. For example, the bank size 255-a may indicate a size of the bank data 230-d. In some instances, the bank size 255-a data within the bank header 245 may include 4 bytes of data. The bank header 245 may include additional bank sizes 255 indicating the size of the bank data 230-e and the size of the bank data 230-f.

In some cases, the bank header 245 may additionally include bank error control information 260 corresponding to the bank data 230. For example, the bank header 245 may include the bank error control information 260-a corresponding to the bank data 230-d and may additionally include bank error control information 260 corresponding to the bank data 230-e and 230-f. In some cases, a memory system (e.g., a memory system controller, a local controller) may perform an error control operation on the bank data 230 based on the bank error control information corresponding to the bank data 230. Here, the memory system may detect and, in some cases correct, errors within the bank data 230 (e.g., prior to storing or executing the bank data 230). In some cases, the bank error control information 260 may include CRC bits associated with the bank data 230. For example, the bank error control information 260-a may include 2 bytes of CRC data associated with the bank data 230-d.

In an example of a memory system that accesses the firmware data 200-b (e.g., in response to receiving the firmware data 200-b from a host system), the memory system (e.g., a memory system controller, a local controller) may determine that the firmware data 200-b includes compressed bank firmware data 265 based on an indication within the firmware header 205-b. Then, the memory system may decompress the bank data 230. For example, the memory system may read the bank data 230 within the compressed bank firmware data 265 based on identifying a boundary of each bank data 230. That is, the memory system may identify the boundary of each bank data 230 based on the bank header 245 indicating the bank count 250 and the bank size 255 of the bank data 230 within the compressed bank firmware data 265. For example, the memory system may read a first quantity of bits of the compressed bank firmware data 265 (e.g., corresponding to the bank data 230-d) indicated by the bank size 255-a. Then, the memory system may identify the boundary of the second bank data 230 based on the indicated bank size 255-a. Here, the memory system may read a second quantity of bits of the compressed bank firmware data 265 (e.g., corresponding to the bank data 230-e) indicated by a second bank size 255 in the bank header 245. The memory system may repeat this process based on the bank count 250. For example, if the bank count 250 indicates the compressed bank firmware data 265 includes three bank data 230, the memory system may read quantities of bits indicated by the bank size 255 three times. Based on reading the bank data 230, the memory system (e.g., a memory system controller, a local controller) may store the bank data 230 and, in some cases, execute the bank data 230.

FIG. 3 illustrates an example of a process flow 300 that supports compressing firmware data in accordance with examples as disclosed herein. The process flow 300 may include aspects of a system and firmware data as described with reference to FIGS. 1 and 2. For example, a memory system may implement the process flow 300 based on firmware data as described with reference to FIGS. 1 and 2. Aspects of the process flow 300 may be implemented by a controller, among other components. Additionally, or alternatively, aspects of the process flow 300 may be implemented as instructions stored in memory (e.g., firmware stored in a memory coupled with the memory system 110, the memory devices 130). For example, the instructions, when executed by a controller (e.g., the memory system controller 115, a local controller 135), may cause the controller to perform the operations of the process flow 300.

At 305, firmware data may be accessed (e.g., by a memory system controller, by a local controller). For example, a memory system may access the firmware data by receiving the firmware data from a host system. In some cases, the memory system may access the firmware data as part of an initialization procedure (e.g., a boot-up procedure, a start-up procedure) of the memory system. In some other cases, the memory system may access the firmware data as part of a procedure to update the firmware data.

At 310, a determination of whether the bank data within the firmware data is compressed may be made. For example, the memory system may determine whether the firmware data includes compressed bank data or aligned bank data. In some cases, the memory system may determine whether the bank data is compressed based on the firmware data including an indication of whether the firmware data includes compressed bank data. For example, the memory system may read a firmware header (e.g., a header in the firmware data indicating a composition of the firmware data) to determine whether the bank data is compressed. In cases that the memory system determines that the bank data is compressed, the memory system may proceed to 315. In cases that the memory system determines that the bank data is not compressed (e.g., that the bank data is aligned), the memory system may proceed to 320.

At 315, the bank data may be decompressed (e.g., to obtain the bank data). For example, the memory system may identify a composition of the compressed bank data based on a bank header within the firmware data. For example, the header may indicate a quantity of bank data within the compressed bank data, and a size of each bank data within the compressed bank data. Then, the memory system may decompress the compressed bank data by identifying, for each of the quantity of bank data within the compressed bank data, a portion of the compressed bank data comprising the bank data associated with one bank, and reading the identified portion of the compressed bank data.

At 320, an error control operation may be performed on the bank data. For example, the firmware data may include error control information associated with the bank data (e.g., within a bank header, within a firmware header). Here, the memory system may perform the error control operation on the bank data based on the error control information to detect and, in some cases, correct errors within the bank data.

At 325, the bank data may be stored. For example, the memory system may store the bank data at a controller of the memory system. In another example, the memory system may store the bank data at a memory device of the memory system. Additionally, or alternatively, the memory system may execute the bank data. For example, a controller associated with the memory system may execute the bank data (e.g., as part of a start-up or boot-up procedure of the memory system, in response to running a system on-chip associated with the bank data).

At 330, access operations may be performed at the memory system. For example, based on storing and executing the bank data, the memory system may access one or more memory devices at the memory system.

FIG. 4 shows a block diagram 400 of a memory system 420 that supports compressing firmware data in accordance with examples as disclosed herein. The memory system 420 may be an example of aspects of a memory system as described with reference to FIGS. 1 through 3. The memory system 420, or various components thereof, may be an example of means for performing various aspects of compressing firmware data as described herein. For example, the memory system 420 may include a firmware accessor 425, a compressed bank data identifier 430, a decompression component 435, a compression identifier 440, an access operation component 445, an error control component 450, or any combination thereof. Each of these components may communicate, directly or indirectly, with one another (e.g., via one or more buses).

The firmware accessor 425 may be configured as or otherwise support a means for accessing firmware data associated with a memory system, the firmware data including a plurality of compressed bank data that includes information about a plurality of banks at the memory system and a bank header indicating a composition of the plurality of bank data. The compressed bank data identifier 430 may be configured as or otherwise support a means for identifying, based at least in part on the bank header indicating the composition, a portion of the firmware data including a first compressed bank data from the plurality of compressed bank data, the first compressed bank data corresponding to a first bank of the plurality of banks. The decompression component 435 may be configured as or otherwise support a means for decompressing, based at least in part on the identifying, the first compressed bank data to obtain a first bank data corresponding to the first bank of the plurality of banks.

In some examples, the compression identifier 440 may be configured as or otherwise support a means for determining whether the firmware data includes the plurality of compressed bank data or a second plurality of decompressed bank data, where identifying the portion of the firmware data including the first compressed bank data is based at least in part on determining that the firmware data includes the plurality of compressed bank data.

In some examples, the firmware data includes an indication of whether the firmware data includes the plurality of compressed bank data or whether the firmware data includes the second plurality of decompressed bank data. In some examples, determining that the firmware data includes the plurality of compressed bank data is based at least in part on the indication.

In some examples, the firmware data includes a firmware header indicating a composition of the firmware data. In some examples, the firmware header includes the indication of whether the firmware data includes the plurality of compressed bank data or the second plurality of decompressed bank data.

In some examples, to support decompressing, the decompression component 435 may be configured as or otherwise support a means for reading the identified portion of the firmware data including the first compressed bank data to obtain the first bank data.

In some examples, the bank header includes a plurality of sizes associated with the plurality of compressed bank data.

In some examples, the bank header includes an indication of a quantity of the plurality of compressed bank data.

In some examples, the bank header includes a plurality of error control information corresponding to the plurality of compressed bank data.

In some examples, the error control component 450 may be configured as or otherwise support a means for performing, based at least in part on the decompressing, an error control operation on the first bank data based at least in part on first error control information of the plurality of error control information.

In some examples, the access operation component 445 may be configured as or otherwise support a means for storing the first bank data at a controller of the memory system based at least in part on the decompressing.

In some examples, the firmware accessor 425 may be configured as or otherwise support a means for receiving the firmware data from a host system, where accessing the firmware data is based at least in part on receiving the firmware data.

FIG. 5 shows a flowchart illustrating a method 500 that supports compressing firmware data in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include accessing firmware data associated with a memory system, the firmware data including a plurality of compressed bank data that includes information about a plurality of banks at the memory system and a bank header indicating a composition of the plurality of bank data. The operations of 505 may be performed in accordance with examples as disclosed herein. In some examples, aspects of the operations of 505 may be performed by a firmware accessor 425 as described with reference to FIG. 4.

At 510, the method may include identifying, based at least in part on the bank header indicating the composition, a portion of the firmware data including a first compressed bank data from the plurality of compressed bank data, the first compressed bank data corresponding to a first bank of the plurality of banks. The operations of 510 may be performed in accordance with examples as disclosed herein. In some examples, aspects of the operations of 510 may be performed by a compressed bank data identifier 430 as described with reference to FIG. 4.

At 515, the method may include decompressing, based at least in part on the identifying, the first compressed bank data to obtain a first bank data corresponding to the first bank of the plurality of banks. The operations of 515 may be performed in accordance with examples as disclosed herein. In some examples, aspects of the operations of 515 may be performed by a decompression component 435 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for accessing firmware data associated with a memory system, the firmware data including a plurality of compressed bank data that includes information about a plurality of banks at the memory system and a bank header indicating a composition of the plurality of bank data; identifying, based at least in part on the bank header indicating the composition, a portion of the firmware data including a first compressed bank data from the plurality of compressed bank data, the first compressed bank data corresponding to a first bank of the plurality of banks; and decompressing, based at least in part on the identifying, the first compressed bank data to obtain a first bank data corresponding to the first bank of the plurality of banks.

Aspect 2: The method, apparatus, or non-transitory computer-readable medium of aspect 1, further including operations, features, circuitry, logic, means, or instructions, or any combination thereof for determining whether the firmware data includes the plurality of compressed bank data or a second plurality of decompressed bank data, where identifying the portion of the firmware data including the first compressed bank data is based at least in part on determining that the firmware data includes the plurality of compressed bank data.

Aspect 3: The method, apparatus, or non-transitory computer-readable medium of aspect 2 where the firmware data includes an indication of whether the firmware data includes the plurality of compressed bank data or whether the firmware data includes the second plurality of decompressed bank data and determining that the firmware data includes the plurality of compressed bank data is based at least in part on the indication.

Aspect 4: The method, apparatus, or non-transitory computer-readable medium of aspect 3 where the firmware data includes a firmware header indicating a composition of the firmware data and the firmware header includes the indication of whether the firmware data includes the plurality of compressed bank data or the second plurality of decompressed bank data.

Aspect 5: The method, apparatus, or non-transitory computer-readable medium of any of aspects 1 through 4 where the decompressing includes operations, features, circuitry, logic, means, or instructions, or any combination thereof for reading the identified portion of the firmware data including the first compressed bank data to obtain the first bank data.

Aspect 6: The method, apparatus, or non-transitory computer-readable medium of any of aspects 1 through 5 where the bank header includes a plurality of sizes associated with the plurality of compressed bank data.

Aspect 7: The method, apparatus, or non-transitory computer-readable medium of any of aspects 1 through 6 where the bank header includes an indication of a quantity of the plurality of compressed bank data.

Aspect 8: The method, apparatus, or non-transitory computer-readable medium of any of aspects 1 through 7 where the bank header includes a plurality of error control information corresponding to the plurality of compressed bank data.

Aspect 9: The method, apparatus, or non-transitory computer-readable medium of aspect 8, further including operations, features, circuitry, logic, means, or instructions, or any combination thereof for performing, based at least in part on the decompressing, an error control operation on the first bank data based at least in part on first error control information of the plurality of error control information.

Aspect 10: The method, apparatus, or non-transitory computer-readable medium of any of aspects 1 through 9, further including operations, features, circuitry, logic, means, or instructions, or any combination thereof for storing the first bank data at a controller of the memory system based at least in part on the decompressing.

Aspect 11: The method, apparatus, or non-transitory computer-readable medium of any of aspects 1 through 10, further including operations, features, circuitry, logic, means, or instructions, or any combination thereof for receiving the firmware data from a host system, where accessing the firmware data is based at least in part on receiving the firmware data.

It should be noted that the methods described above describe possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” refers to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed and second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed and second condition or action may occur directly as a result of the previous condition or action occurring independent of whether other conditions or actions occur. In some examples, a first condition or action may be performed and second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally or alternatively (e.g., in an alternative example) be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorous, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to providing an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processor, firmware, or any combination thereof. If implemented in software executed by a processor, the functions may be stored on or transmitted over, as one or more instructions or code, a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

For example, the various illustrative blocks and components described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may be implemented as a combination of computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk, and Blu-ray disc, where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus, comprising:
a plurality of banks; and
a controller coupled with the plurality of banks and configured to cause the apparatus to:
access firmware data associated with the apparatus, the firmware data comprising a plurality of compressed bank data that includes information about the plurality of banks at the apparatus and a bank header indicating a composition of the plurality of compressed bank data;
identify, based at least in part on the bank header indicating the composition, a portion of the firmware data comprising a first compressed bank data from the plurality of compressed bank data, the first compressed bank data corresponding to a first bank of the plurality of banks; and
decompress, based at least in part on the identifying, the first compressed bank data to obtain a first bank data corresponding to the first bank of the plurality of banks.

2. The apparatus of claim 1, wherein the controller is further configured to cause the apparatus to:
determine whether the firmware data comprises the plurality of compressed bank data or a second plurality of decompressed bank data, wherein identifying the portion of the firmware data comprising the first compressed bank data is based at least in part on determining that the firmware data comprises the plurality of compressed bank data.

3. The apparatus of claim 2, wherein:
the firmware data comprises an indication of whether the firmware data comprises the plurality of compressed bank data or whether the firmware data comprises the second plurality of decompressed bank data; and
determining that the firmware data comprises the plurality of compressed bank data is based at least in part on the indication.

4. The apparatus of claim 3, wherein:
the firmware data comprises a firmware header indicating a composition of the firmware data; and
the firmware header comprises the indication of whether the firmware data comprises the plurality of compressed bank data or the second plurality of decompressed bank data.

5. The apparatus of claim 1, wherein the decompressing is configured to cause the apparatus to:
read the identified portion of the firmware data comprising the first compressed bank data to obtain the first bank data.

6. The apparatus of claim 1, wherein the bank header comprises a plurality of sizes associated with the plurality of compressed bank data.

7. The apparatus of claim 1, wherein the bank header comprises an indication of a quantity of the plurality of compressed bank data.

8. The apparatus of claim 1, wherein the bank header comprises a plurality of error control information corresponding to the plurality of compressed bank data.

9. The apparatus of claim 8, wherein the controller is further configured to cause the apparatus to:
perform, based at least in part on the decompressing, an error control operation on the first bank data based at least in part on first error control information of the plurality of error control information.

10. The apparatus of claim 1, wherein the controller is further configured to cause the apparatus to:
store the first bank data at the controller based at least in part on the decompressing.

11. The apparatus of claim 1, wherein the controller is further configured to cause the apparatus to:
receive the firmware data, wherein accessing the firmware data is based at least in part on receiving the firmware data.

12. A non-transitory computer-readable medium storing code comprising instructions which, when executed by a processor of an electronic device, cause the electronic device to:
access firmware data associated with the electronic device, the firmware data comprising a plurality of compressed bank data that includes information about a plurality of banks at the electronic device and a bank header indicating a composition of the plurality of compressed bank data;
identify, based at least in part on the bank header indicating the composition, a portion of the firmware data comprising a first compressed bank data from the plurality of compressed bank data, the first compressed bank data corresponding to a first bank of the plurality of banks; and
decompress, based at least in part on the identifying, the first compressed bank data to obtain a first bank data corresponding to the first bank of the plurality of banks.

13. The non-transitory computer-readable medium of claim 12, wherein the instructions, when executed by the processor of the electronic device, further cause the electronic device to:
determine whether the firmware data comprises the plurality of compressed bank data or a second plurality of decompressed bank data, wherein identifying the portion of the firmware data comprising the first compressed bank data is based at least in part on determining that the firmware data comprises the plurality of compressed bank data.

14. The non-transitory computer-readable medium of claim 13, wherein:
the firmware data comprises an indication of whether the firmware data comprises the plurality of compressed bank data or whether the firmware data comprises the second plurality of decompressed bank data; and
determining that the firmware data comprises the plurality of compressed bank data is based at least in part on the indication.

15. The non-transitory computer-readable medium of claim 14, wherein:
the firmware data comprises a firmware header indicating a composition of the firmware data; and
the firmware header comprises the indication of whether the firmware data comprises the plurality of compressed bank data or the second plurality of decompressed bank data.

16. The non-transitory computer-readable medium of claim 12, wherein the instructions to decompress the first compressed bank data, when executed by the processor of the electronic device, further cause the electronic device to:
read the identified portion of the firmware data comprising the first compressed bank data to obtain the first bank data.

17. The non-transitory computer-readable medium of claim 12, wherein the bank header comprises a plurality of sizes associated with the plurality of compressed bank data.

18. The non-transitory computer-readable medium of claim 12, wherein the bank header comprises an indication of a quantity of the plurality of compressed bank data.

19. The non-transitory computer-readable medium of claim 12, wherein the bank header comprises a plurality of error control information corresponding to the plurality of compressed bank data.

20. The non-transitory computer-readable medium of claim 19, wherein the instructions, when executed by the processor of the electronic device, further cause the electronic device to:
perform, based at least in part on the decompressing, an error control operation on the first bank data based at least in part on first error control information of the plurality of error control information.

21. The non-transitory computer-readable medium of claim 12, wherein the instructions, when executed by the processor of the electronic device, further cause the electronic device to:
store the first bank data at a controller of the electronic device based at least in part on the decompressing.

22. A method, comprising:
accessing firmware data associated with a memory system, the firmware data comprising a plurality of compressed bank data that includes information about a plurality of banks at the memory system and a bank header indicating a composition of the plurality of compressed bank data;
identifying, based at least in part on the bank header indicating the composition, a portion of the firmware data comprising a first compressed bank data from the plurality of compressed bank data, the first compressed bank data corresponding to a first bank of the plurality of banks; and
decompressing, based at least in part on the identifying, the first compressed bank data to obtain a first bank data corresponding to the first bank of the plurality of banks.

23. The method of claim 22, further comprising:
determining whether the firmware data comprises the plurality of compressed bank data or a second plurality of decompressed bank data, wherein identifying the portion of the firmware data comprising the first compressed bank data is based at least in part on determining that the firmware data comprises the plurality of compressed bank data.

24. The method of claim 23, wherein:
the firmware data comprises an indication of whether the firmware data comprises the plurality of compressed bank data or whether the firmware data comprises the second plurality of decompressed bank data; and
determining that the firmware data comprises the plurality of compressed bank data is based at least in part on the indication.
